(19) United States
(12) Patent Application Publication
(10) Pub. No.: US 2007/0067387 A1
(43) Pub. Date: Mar. 22, 2007

(54) Conferencing system and method for temporary blocking / restoring of individual participants

(75) Inventors: Mukul Jain, San Jose, CA (US); Vinod Katkam, San Jose, CA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/230,074

(22) Filed: Sep. 19, 2005

(51) Int. Cl. G06F 15/16

(52) U.S. Cl. 709/204

(57) ABSTRACT

A conferencing system includes a server having a plurality of ports, the server operating in response to one or more inputs to selectively permit an individual connected to the server via one of the ports to participate in a conference session or be isolated in a waiting room. A computer runs a program to implement a user interface that generates the one or more inputs to the server responsive to commands entered by a moderator using the computer. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to the fields of data networks and communication systems; more specifically, to systems and methods aimed at managing conference sessions for groups of individuals communicating over a telephony network.

### BACKGROUND OF THE INVENTION

Conferencing systems and methods, in which participants communicate in a conference session or meeting over existing voice and data networks, have been in existence for some time. Recent examples of conference calling systems include U.S. Pat. No. 6,865,540, which teaches a method and apparatus for providing group calls via the Internet; U.S. Pat. No. 6,876,734, which teaches an Internet-enabled conferencing system accommodating public switched telephone network (PSTN) and Internet Protocol (IP) traffic; U.S. Pat. No. 6,931,001, which discloses a system for interconnecting packet-switched and circuit-switched voice communications; and U.S. Pat. No. 6,671,262, which teaches a system with conference servers for combining IP packet streams in a conference call into combined packet streams, such that the combined IP packet stream utilizes no more bandwidth than each of the original packet streams.

A variety of different features and approaches for scheduling, control, and management of conference call sessions are also known. For instance, a conferencing system that facilitates a conference call by enabling a participant in the call session to determine and categorize the identities of the other participants is taught in U.S. Pat. No. 6,931,113. A conference calling system in which each participant may individually control incoming audio streams from other participants, and in which participants may communicate privately with each other in the context of the conference call, is disclosed in U.S. Pat. No. 6,501,739. U.S. Pat. No. 6,816,469 teaches an IP telephony network and PSTN network that allows one or more call waiting callers to dynamically join in an existing multiple party conference call session.

In addition, commercially-available IP communication system products such as Cisco's MeetingPlace™ conferencing application allow users to schedule meeting conferences in advance or, alternatively, to set up conferences immediately by dialing out to participant parties. Cisco MeetingPlace™ is typically deployed on a corporate network behind the firewall, and facilitates scheduling of business conferences from a touch-tone or voice over IP (VoIP) telephone, or a computer, using various software clients, such as Microsoft® Outlook, or a web browser.

In a typical conference call, invitees dial in (or the system dials out) and are directly moved into the “main conference room” to join the conference session. However, in certain situations the moderator of the conference may want to control the start of the meeting and configure it such that the meeting may not start until the moderator joins the conference session. With such a configuration, when the conference invitees join the conference session prior to the moderator joining, they are placed in a “waiting room” where they may listen to on-hold music and/or hear meeting announcements. When the moderator joins and is ready to start the meeting, all of the participants in the waiting room are brought into the main meeting room, the waiting room is dissolved, and the conference session begins.

During the meeting, participants may have the ability to mute themselves and/or enter a “breakout” session, in which individuals can establish their own private communication group session apart from the main meeting. The users who participate in the breakout session may return to the main meeting at any time by simply pressing a predetermined keypad code or sequence.

Interruptions may occur during the normal course of a conference session. A typical example is when a manager, acting as the meeting moderator, wants to discuss confidential information with a special subset of the meeting participants. The manager may wish to talk privately with certain project or team leaders, or discuss a particular employee with a human resources department representative. Accommodating such private, confidential discussions is often a problem in existing conferencing systems.

For example, entering a breakout session by the subset of participants is generally inadequate since other users or meeting participants may enter the same session before it becomes locked. Moreover, the moderator lacks the ability to prevent persons from entering, or forcing them to exit, the breakout room. Likewise, merely asking the conference participants who are to be excluded from the confidential discussions to enter a breakout session does not preserve privacy since persons in a breakout room or session usually have the ability to return to the main meeting at their discretion. Additionally, this approach is very inconvenient for the moderator and participants. Furthermore, it may not always be possible to find a free breakout room, and, even if one is available, all required participants may not join the breakout session in a timely manner, thus delaying progress of the conference session.

One solution to the difficulty of implementing confidential “sidebar” discussions in the context of a larger meeting is to ask the other participants (those who are to be excluded) to temporarily leave the conference session. However, this approach is cumbersome since it usually involves having many people first drop out of the conference, wait to be notified (manually, or through another communication channel) that the confidential topic of discussion is over, and then, finally, call back to re-join the conference session. In certain system implementations, conference moderators can drop participants from a meeting, place the entire conference session on hold, or deny certain participants from joining a meeting. But these techniques lack flexibility and particularized control. Currently, there is no system that permits a moderator to temporarily block individuals from participating (i.e., listening and/or speaking) in a conference session without disconnecting the participant's call.

What is needed therefore is a conferencing system and method that overcomes the drawbacks of the prior art and which facilitates private, confidential discussions among a subset of individuals in the context of a conference session having many participants.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a conceptual diagram of a conferencing system in accordance with one embodiment of the present invention.

FIG. 2 is a flowchart diagram that illustrates a method of operation according to one embodiment of the present invention.

FIG. 3 illustrates a user interface window associated with an application running on a PC of a user in accordance with one embodiment of the present invention.

### DETAILED DESCRIPTION

A conferencing system and method that provides a meeting organizer or moderator (both terms are used synonymously in the present application) with control to selectively and forcibly move individual participants into or out of a waiting room that isolates the participants from the main conference room or session is described. In the following description specific details are set forth, such as device types, system configurations, protocols, applications methods, etc., in order to provide a thorough understanding of the present invention. However, persons having ordinary skill in the relevant arts will appreciate that these specific details may not be needed to practice the present invention.

According to one embodiment of the present invention, a mechanism under the control of a conference moderator is provided in which certain selected ports of a conference server, each of which is correspondingly associated with an individual participant, are temporarily blocked. The blocked participants no longer have the ability to hear or speak in the conference session. During the time that the ports are blocked, the conferencing system also precludes the blocked participants from dropping out (i.e., hanging up) and dialing back into the conference session. After a certain time period, the moderator may unblock or restore selected (or all) ports to allow those participants to re-enter into the conference session.

The media path for the conference participants may include audio (voice) and video transmissions across a variety of different networks (e.g., Internet, intranet, PSTN, etc.), protocols (e.g., IP, Asynchronous Transfer Mode (ATM), Point-to-Point Protocol (PPP)), with connections that span across multiple services, systems, and devices (e.g., private branch exchange (PBX) systems, VoIP gateways, etc.). In a specific embodiment, the present invention may be implemented by software or hardware (firmware) installed in an IP communications system that includes components such as Cisco System's IP Communicator, Call Manager, MeetingPlace, Softphone (a PC that has phone capabilities installed), and other IP phone/communication products. Alternative embodiments of the present invention may be implemented in PBX, telephony, telephone, and other telecommunications systems.

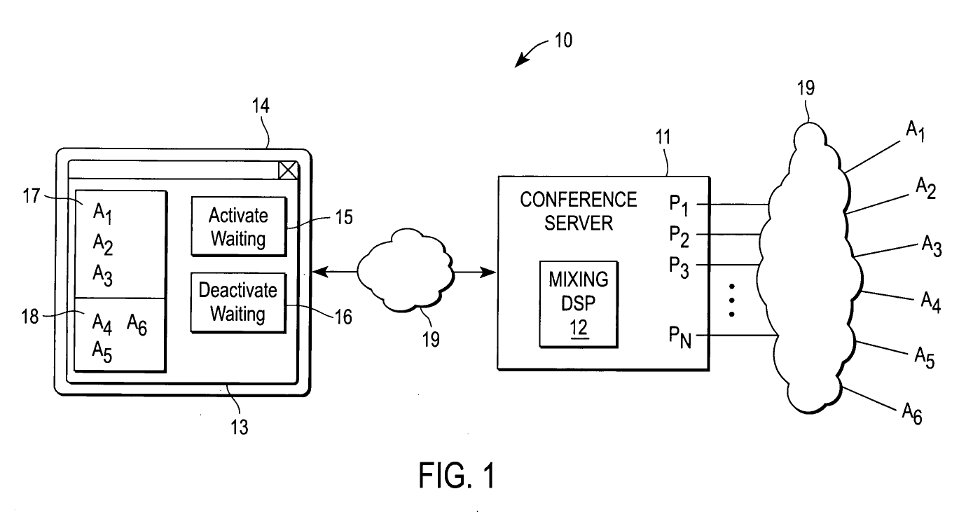

Referring to FIG. 1, an exemplary conferencing system 10 in accordance with one embodiment of the present invention is shown including a conference server 11 coupled with a PC 14 associated with the conference organizer or moderator for communications therebetween. Conference server 11 includes a digital signal processor (DSP) 12 that mixes audio signals received at ports (P₁-P_{N}), which are configured for connection with a set of a conference or meeting participants (A₁-A₆). Participants A₁-A₆ are shown being connected with corresponding ports of server 11 via “cloud” 19, which represents one or more networks or other communication media. For example, some participants may connect to server 11 through an IP network, some may connect via a PSTN, and still others may dial in through corporate intranet/PBX system—all of which are subsumed by the representation of cloud 19. FIG. 1 also shows PC 14 connected with server 11 via network cloud 19.

Regardless of how the physical connection is made, participants who dial into a conference session are each assigned a dedicated port of server 11 for the duration of the session. During an active conference session, the received audio signals are mixed by DSP 12 and then sent back out to each of the participants via the individual ports P₁-P_{N}.

PC 14 of the moderator is shown with a graphical user interface (GUI) 13 that includes a waiting room display field 17, a main conference room display field 18 and respective activate waiting/deactivate waiting buttons (icons) 15 & 16. In one embodiment, GUI 13 is an interactive interface (e.g., a web-based graphical user interface) that allows a conference moderator to control the blocking/unblocking of individual participants who have dialed into the conference session. In one implementation, GUI 13 is generated by software (i.e., code) running the moderator's PC in communication with conference server 11. That is, responsive to commands entered via GUI 13, the PC generates one or more signals or packet messages sent via an external interface to conference server 11. These signals or packet messages cause server 11 to block/unblock ports associated with selected individuals.

It is appreciated that the graphical user interface may comprise a collaborative web-based application that is accessed by the browser software running on PC 14. In other instances, GUI 13 may comprise a downloaded application for execution on the moderator's PC, or other forms of computer-executable code that may be loaded or accessed by PC 14.

In the example of FIG. 1, participants who dial into the conference session are first placed into a waiting room, where they may listen to music, meeting announcements, or a script message that informs the caller that the conference session will begin shortly. Typically, a conference session begins when the meeting organizer or moderator calls into conference server 11. Conference sessions may also be configured such that the meeting cannot start until all pre-designated key participants (including the moderator) have called into the conference session. When the moderator (and other key participants, if applicable) has dialed into conference server 11, the conference session is activated and everyone in the waiting room is moved into the main conference room. All participants in the main conference room may talk and listen to discussions among everyone.

After the conference session has started, the moderator may observe all of the participants by viewing main conference room display field 18, which shows the name (or other ID) of each participant. In this example, the moderator may also select or “click” on button 15 appearing on the graphical user interface to activate the waiting room control function. Once the moderator clicks activate waiting button 15, nobody is permitted to directly join into the main conference room; instead, any person who attempts to join after the conference session has commenced is placed into the waiting room. Practitioners will appreciate that in a specific embodiment, deactivate waiting button 16 becomes enabled or “clickable” upon clicking activate waiting button 15. Other embodiments may utilize a single button that toggles to change between activate/deactivate waiting commands.

Graphical user interface 13 displays the name or ID of late individuals in waiting room display field 17. At any time, the moderator may select one or more of the individuals appearing in waiting room display field 17 and move them (e.g., click, drag and drop using a mouse, keyboard, touch-screen, or other command input device) into main conference room display field 18 to allow them to participate in meeting discussions in the main conference room. Alternatively, the moderator may click button 16 to deactivate the waiting room function. Clicking on button 16 has the effect of immediately moving all of the individuals from the waiting room into the main conference room. In addition, deactivating the waiting room function may allow others (e.g., other meeting late-comers) to directly enter the main conference room.

It should be understood that in the context of the present invention, it is assumed that all conference participants can be identified in a given conference session. This can be achieved by enforcing every participant to authenticate their identity before joining the conference session.

With the waiting room function activated, the moderator also has the ability to select one or more participants from main conference room display field 18 and move them into waiting room display field 17. This action forcibly removes those conference participants from the main conference room, effectively excluding and isolating them from on-going meeting discussions in the main conference room. In one embodiment, anyone in the waiting room can send a request (e.g., instant message or whisper) to the moderator to join or enter into the main conference room. For example, GUI 13 may notify the moderator of the join request by displaying a flashing character or other symbol next to the requestor's name in waiting room display field 17. The moderator may either accept (e.g., by dragging and dropping the person from field 17 to field 18) or deny (e.g., by ignoring) the request to enter the main conference room. In other words, control over which participants may enter the main conference room resides with the moderator, not the caller or participant.

Practitioners in the arts will understand that multiple alternative ways of designating persons for active participation in or isolation from a conference session are possible. For example, instead of separate waiting room and main conference room display fields, GUI 13 may simply display a listing of all conference participants with each person having one or more fields adjacent their name that controls their respective participation in the conference session. For instance, activating or clicking on a person's name, or a waiting room field next to their name, may isolate that person from the main conference session. An appropriate identifier may be displayed so the moderator may track who is actively participating in the conference session, and who is currently being isolated in the waiting room.

The actual implementation and configuration details of how participants are moved between the waiting and main conference rooms may vary greatly. In one embodiment, for example, when the moderator activates the waiting room function PC 14 sends a signal to conference server 11 that causes server 11 to block the audio signals at all ports of participants currently shown in waiting room display field 17. For instance, in FIG. 1 participants A₁-A₃ are shown in waiting room display field 17, and participants A₄-A₆ are shown in main conference room display field 18. Server 11 therefore responds to this control setting or state by blocking audio mixing at those ports dedicated to participants A₁-A₃. That is, incoming audio signals as well as mixed audio signals generated by DSP 12 are blocked at the media ports connected to participants A₁-A₃. The current blocking state (i.e., which ports are blocked and which are not) at conference server 11 may change dynamically throughout the duration of the conference session, depending upon the control selections made by the moderator via GUI 13.

Another possible implementation in a VolP system implementation is to configure the system to operate in accordance with a protocol that can re-negotiate the conference session on a per participant basis. For example, this may involve sending a request message to the end point devices to stop sending/receiving Real-Time Transport Protocol (RTP) packets. Resumption of a person's participation in the main conference session may be accomplished via a Re-Invite message using the Session Initiation Protocol (SIP).

When the moderator requests the system to unblock certain ports (e.g., by moving participants from the waiting room to the main conference room) the media path to those participants is restored. Practitioners in the art will appreciate that during the time that participants are blocked they still stay connected and do not have to dial back into the conference session once their media path is restored by the conference moderator. Furthermore, blocked meeting participants (i.e., those individuals in the waiting room) do not have to manually notify all the conference moderator in order to rejoin the main conference room, since this operation is in the control of the moderator, who can visual see and change the status of each participant.

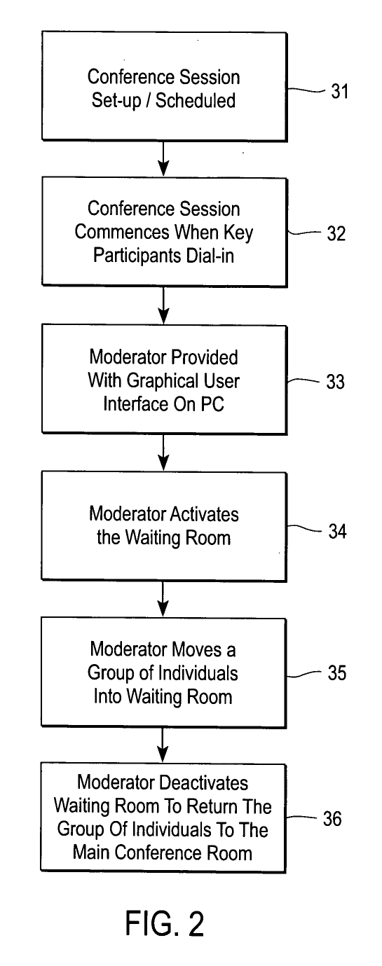

FIG. 2 is a flowchart diagram that illustrates a method of operation according to one embodiment of the present invention. The process starts (block 31) with the scheduling of set-up of the conference session. This is typically done well in advance of the meeting, for example, from a touch-tone or IP telephone or a computer using software such as Cisco's MeetingTime client software, Microsoft Outlook, or a web browser. Once the conference has been scheduled, the conferencing system reserves the necessary resources and guarantees availability at the time of the meeting. Information such as the date, start time, and length of the conference, the number of audio/video locations, a meeting ID, meeting preferences, meeting moderator(s), etc., is usually stored on the conference server. When the moderator (and other key participants, if so designated) arrives, the meeting is called to order and all waiting room participants are brought into the main conference room (block 32). When the moderator dials-into the conference session he is provided with a graphical user interface which allows him to activate/deactivate the waiting room function and block/restore participants during the meeting as described above (block 33).

In the example flow of FIG. 2, the moderator first activates the waiting room function (block 34) and then moves a group of selected individuals out of the main conference room into the waiting room (block 35). Block 36 shows the moderator subsequently deactivating the waiting room function, which has the effect of returning all of the participants (in the waiting room) to the main conference room.

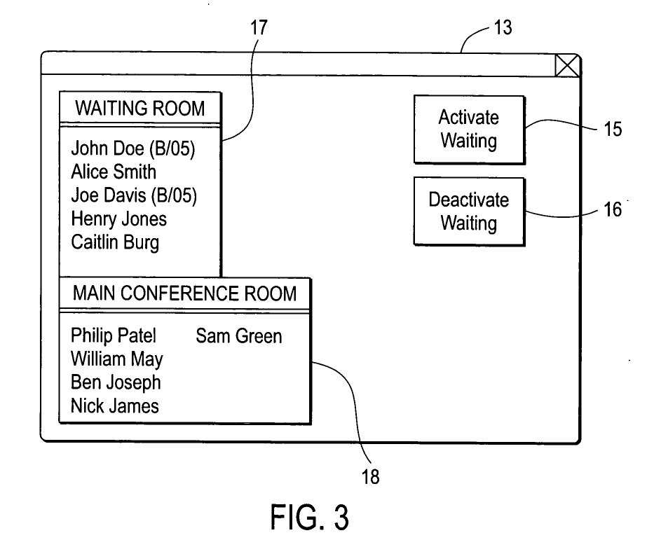

FIG. 3 is another example that illustrates a graphical user interface 13 associated with an application running on a PC of a user in accordance with one embodiment of the present invention. As before, GUI 13 includes respective activate waiting and deactivate waiting buttons 15 and 16, and two lists of conference participants. Waiting room display field 17 is shown populated with the names of five participants (i.e., John Doe, Alice Smith, Joe Davis, Henry Jones and Caitlin Burg). These individuals might have arrived after the moderator activated the waiting mode (e.g., clicked on the “activate waiting” button), or have been moved into the waiting room by the moderator for the purpose of temporarily blocking this group from participating in discussions in the main conference room. As can be seen, the moderator's main conference room display field 18 is populated with the names of five people (i.e., Philip Patel, William May, Ben Joseph, Nick James, and Sam Green, who in this example is the moderator). When the moderator wants to restore the ability of the isolated participants to speak and listen in the main conference session, he may do so by clicking deactivate waiting button 18.

Additionally, the example of FIG. 3 illustrates two participants (John Doe and Joe Davis) entering into a breakout session while in the waiting room. The fact that these two individuals are in a breakout session is conveyed to the moderator by the notion “(B/05)” next to their names. (The letter “B” indicates a breakout session and “05” identifies the number of the breakout room.) In accordance with one embodiment of the present invention, participants may enter a breakout session (e.g., by pressing a certain keypad command sequence, or function key button on their phone or PC) where they may engage in private conversations apart from other persons in the waiting room. Other participants may not listen to or speak with the individuals in the breakout session. However, when the breakout session is terminated by the participants, they return to the waiting room. In the case where the moderator has deactivated the waiting room function, ending of the breakout session automatically returns those participants to the main conference room.

It should be understood that the breakout session feature does not override the organizer's ability to force participants into the waiting room and then keep them isolated there for a variable amount of time until the private discussions in the main conference room have completed. In other words, while participants may move themselves into a breakout room, the organizer retains control over who is permitted to participate (speak, listen, or observe) in the main conference room discussions.

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For example, in certain implementations the waiting room may be subdivided into areas that provide different categories of meeting participation. For example, there may be an area that allow individuals to audit (i.e., listen but not speak) main conference room discussions in addition to an area that completely isolates individuals from the main conference room. Yet another subdivision area might be used to preclude persons from entering into a breakout session while in the waiting room. Accordingly, the specification and drawings are to be regarded in an illustrative rather than a restrictive sense.

We claim:

1. A conferencing system comprising:
a server having a plurality of ports, the server being operable to selectively permit an individual connected to the server via one of the ports to participate in a conference session or be isolated in a waiting room, the server operating in response to one or more inputs; and
a computer that runs a program to implement a user interface, the user interface generating the one or more inputs to the server responsive to commands entered by a moderator using the computer during the conference session.

2. The conferencing system of claim 1 wherein the user interface includes a main conference room field that displays a first set of individuals who may participate in the conference session, and a waiting room field that displays a second set of individuals who are isolated from the conference session.

3. The conferencing system of claim 1 wherein the commands are entered by the moderator via an input device of the computer.

4. The conferencing system of claim 1 wherein a first input causes the server to block a port of a selected individual, and a second input causes the server to restore the port of a selected individual.

5. The conferencing system of claim 1 wherein the server further comprises a digital signal processor for mixing audio signals received at the ports.

6. A computer for connecting with a conferencing server to control participation in a conference session, comprising:
a display;
a program that runs on the computer to produce a graphical user interface on the display, the graphical user interface providing a conference moderator using the computer with main conference room and waiting room fields, and the ability to selectively move individuals between the main conference room and waiting room display fields during the entirety of the conference session, the graphical user interface generating a first output in response to an individual being moved from the main conference room field into the waiting room field, and a second output in response to the individual being moved from the waiting room field into the main conference room field; and
an external interface for transmitting the first and second outputs to the conferencing server, a first command causing the conferencing server to allow a first set of the individuals in the main conference room to actively participate in the conference session, and a second command blocking causing the conferencing server to isolate a second set of the individuals in the waiting room from active participation in the conference session.

7. The computer of claim 6 wherein the graphical user interface further provides a first button to activate the waiting room field.

8. The computer of claim 7 wherein the graphical user interface further provides a second button for automatically moving all of the second set of individuals from the waiting room field into the main conference room field.

9. The computer of claim 6 further comprising an input device for moving the individuals between the main conference room and waiting room fields.

10. A computer for connecting with a conferencing server to control participation in a conference session, comprising:
a display;
means for producing a graphical user interface on the display, the graphical user interface providing a conference moderator using the computer with main conference room and waiting room display fields, and the ability to selectively move individuals between the main conference room and waiting room display fields during the entirety of the conference session, the graphical user interface generating a first output in response to an individual being moved from the main conference room display field into the waiting room display field, and a second output in response to the individual being moved from the waiting room display field into the main conference room display field; and
an external interface for transmitting the first and second outputs to the conferencing server, a first command causing the conferencing server to allow a first set of the individuals in the main conference room to actively participate in the conference session, and a second command blocking causing the conferencing server to isolate a second set of the individuals in the waiting room from active participation in the conference session.

11. A computer for connecting with a conferencing server to control participation in a conference session, comprising:
means for producing a user interface that provides a conference moderator using the computer with main conference room and waiting room fields, and the ability to selectively move individuals between the main conference room and waiting room fields during the entirety of the conference session; and
an interface to transmit first and second outputs to the conferencing server, the first output being produced when the conference moderator moves an individual from the main conference room field to the waiting room field, and the second output being produced when the conference moderator moves the individual from the waiting room field to the main conference room field, the first output causing the conferencing server to block conference audio signal transmission to the individual, and the second output causing the conferencing server to restore conference audio signal transmission to the individual.

12. A processor-implemented method for controlling a conference session comprising:
generating a graphical user interface on a display of a computer, the graphical user interface including first and second identifiers for association with first and second sets of individuals, respectively, the first set of individuals being allowed to actively participate in the conference session, and the second set of individuals being isolated from active participation in the conference session;
executing a first command that moves an individual from the first set to the second set, thereby isolating the individual from active participation in the conference session;
executing a second command that moves the individual from the second set to the first set, thereby allowing the individual to actively participate in the conference session.

13. The processor-implemented method of claim 12 wherein the first identifier comprises a main conference room display field.

14. The processor-implemented method of claim 12 wherein the second identifier comprises a waiting room display field.

15. The processor-implemented method of claim 12 further comprising:
communicating with a conference server to schedule the conference session.

16. A processor-implemented method for controlling a conference session comprising:
generating a graphical user interface on a display of a computer, the graphical user interface including waiting room and main conference room fields, with participates connected to a conference server appearing in the main conference field at the start of the conference session;
moving, under the control of a conference moderator, an identifier associated with an individual from the main conference room field to the waiting room field, thereby isolating the individual from active participation in the conference session; and
moving, under the control of the conference moderator, the identifier associated with the individual from the waiting room field to the main conference room field, thereby allowing the individual to actively participate in the conference session.

17. The processor-implemented method of claim 16 wherein the identifier comprises a name of the individual.

18. A computer program product comprising a computer useable medium and computer readable code embodied on the computer useable medium, execution of the computer readable code causing the computer program product to:
provide a graphical user interface that allows a conference moderator to selectively control media access of participants to a conference session; and
output a first data packet to a conference server responsive to a first input command to the graphical user interface by the conference moderator, the first data packet causing the conference server to block a media path of a selected individual participant connected to the conference session via a port of the conference server.

19. The computer program product of claim 18 wherein execution of the computer readable code further causing the computer program product to:
output a second data packet to a conference server responsive to a second input command to the graphical user interface by the conference moderator, the second data packet causing the conference server to restore a media path of a selected individual participant connected to the conference session via a port of the conference server.
